(19) United States
(12) Patent Application Publication
(10) Pub. No.: US 2010/0133728 A1
(43) Pub. Date: Jun. 3, 2010

(54) CURABLE COMPOSITION FOR PHOTOIMPRINT, AND METHOD FOR PRODUCING CURED PRODUCT USING SAME

(75) Inventors: Hiroyuki Yonezawa, Haibara-gun (JP); Takashi Takayanagi, Fujinomiya-shi (JP); Kyouhei Sakita, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/629,625

(22) Filed: Dec. 2, 2009

(30) Foreign Application Priority Data
Dec. 3, 2008 (JP) 2008-308839

(51) Int. Cl. B29C 35/08; C08F 2/46

(52) U.S. Cl. 264/496; 522/182

(57) ABSTRACT

A curable composition for photoimprints containing a photopolymerizable monomer and a photopolymerization initiator, wherein the proportion of the compound having a molecular weight of at most 190 in the composition is at most 20% by mass, and the viscosity of the composition is from 3 to 50 mPa·s at 25° C., is excellent in patterning accuracy.

### BACKGROUND OF THE INVENTION

1. Field of the Invention

The present invention relates to a curable composition for photoimprints, and to a method for producing a cured product using it.

2. Description of the Related Art

An imprinting method is a technique developed from an embossing technique well known in production of optical discs, and the method comprises pressing a mold original with micropatterns formed thereon (generally it may be referred to also as mold, stamper or template) against a resist to thereby mechanically deform it for precision transfer of the micropatterns onto the resist. Once the mold is produced, nanostructures can be repeatedly shaped with it in a simplified manner, and the method is therefore economical and is a nanoprocessing technique discharging few harmful wastes and emissions, and this is expected to be applicable to various fields.

Of the imprinting method, in particular, a photoimprinting system that comprises photocuring a curable composition for imprints by irradiation with light through a transparent mold, is useful as enabling imprinting at room temperature (see M. Colbun et al., Proc. SPIE, Vol. 676, 78 (1999)). These days photoimprinting is being applied to production of high-density semiconductor integrated circuits and to production of transistors or in-cell protective films for use in liquid-crystal displays, in place of conventional lithography, and the approach to practical use of the technology is now much activated.

For example, WO98/47954 discloses a curable composition comprising a radiation-curable oligomer having a number-average molecular weight of from 700 to 10,000, a radiation-curable monomer diluent, and a specific photopolymerization initiator.

Patent JP-A 2005-263946 discloses a curable composition comprising diol compound, a diisocyanate compound in an amount of from 1.1 to 1.8 molar equivalents to the diol compound, a specific acrylate compound, a photopolymerization initiator and a silane coupling agent.

However, the requirement for the patterning accuracy with curable compositions for photoimprints is being all the more severe year by year, and the above-mentioned curable compositions are not sufficient.

### SUMMARY OF THE INVENTION

The present inventors have assiduously studied and, as a result, have known that the compositions illustrated in Examples of the above-mentioned Patent References, WO98/47954 and JP-A 2005-263946, have an extremely high viscosity and are therefore substantially unusable in photoimprint compositions.

The present invention has been made in consideration of the above-mentioned situation, and its object is to provide a novel curable composition for imprints excellent in photocurability and in patterning accuracy.

Given the situation as above, the inventors have further assiduously studied and, as a result, have found that the following means can solve the above-mentioned problems.

(1) A curable composition for photoimprints containing a photopolymerizable monomer (A) and a photopolymerization initiator (B), wherein the proportion of the compound having a molecular weight of at most 190 in the composition is at most 20% by mass, and the viscosity of the composition is from 3 to 50 mPa·s at 25° C.

(2) The composition of (1), wherein the proportion of the compound having a molecular weight of at most 190 in the composition is at most 10% by mass.

(3) The composition of (1), wherein the proportion of the compound having a molecular weight of at most 190 in the composition is at most 5% by mass.

(4) The composition of any one of (1) to (3), wherein at least one of the photopolymerizable monomer (A) has a (meth) acrylate group.

(5) The composition of any one of (1) to (4), wherein at least one of the photopolymerizable monomer (A) has a viscosity of at most 10 mPa·s at 25° C.

(6) The composition of any one of (1) to (5), wherein at least one of the photopolymerizable monomer (A) is di- or more functional.

(7) The composition of (6), which contains the di- or more functional photopolymerizable monomer in an amount of at least 50% by mass.

(8) The composition of any one of (1) to (7), which contains a surfactant.

(9) The composition of any one of (1) to (8), which contains an antioxidant.

(10) A method for forming a cured product, comprising using a composition of any one of (1) to (9).

(11) A method for producing a cured product, comprising applying a composition of any one of (1) to (9) onto a substrate to form a patterning layer thereon, pressing a mold against the surface of the patterning layer, and irradiating the patterning layer with light.

(12) The method for producing a cured product of (11), which further comprises heating the light-irradiated pattering layer.

The invention has made it possible to provide a curable composition for photoimprints excellent in patterning accuracy.

### BEST MODE FOR CARRYING OUT THE INVENTION

The contents of the invention are described in detail hereinunder. In this specification, the numerical range expressed by the wording “a number to another number” means the range that falls between the former number indicating the lowermost limit of the range and the latter number indicating the uppermost limit thereof. In this specification, mass ratio is equal to weight ratio.

In this specification, “(meth)acrylate” means acrylate and methacrylate; “(meth)acrylic” means acrylic and methacrylic; “(meth)acryloyl” means acryloyl and methacryloyl. In the invention, monomer is differentiated from oligomer and polymer, and the monomer indicates a compound having a weight-average molecular weight of at most 1,000. In this specification, “functional group” means a group participating in polymerization.

“Imprint” referred to in the invention is meant to indicate pattern transfer in a size of from 1 nm to 10 mm and preferably meant to indicate pattern transfer in a size of from 10 nm to 100 μm, more preferably meant to indicate pattern transfer in a size of from 10 nm to 50 μm, particularly preferably meant to indicate pattern transfer in a size of from 100 nm to 50 μm.

### [Curable Composition for Photoimprints]

The curable composition for photoimprints of the invention (hereinafter this may be simply referred to as “composition of the invention”) is a curable composition for photoimprints containing (A) a photopolymerizable monomer and (B) a photopolymerization initiator, wherein the proportion of the compound having a molecular weight of at most 190 to all the ingredients is at most 20% by mass, and the viscosity of the composition is from 3 to 50 mPa·s at 25° C.

The curable composition for photoimprints of the invention is widely usable in photoimprint lithography, and has the following characteristics.

(1) The composition of the invention is excellent in solution flowability at room temperature, and therefore the composition can readily flow into the cavity of the recesses of a mold. Since air is hardly taken into the cavity, the composition is free from bubble defects, and in both the projections and recesses of the mold, the composition residue remains little after photocuring.

(2) The cured film formed by curing the composition of the invention is excellent in mechanical properties, and the adhesiveness between the coating film and the substrate is excellent. In addition, since the coating film is excellent in peelability from mold, the film is free from a trouble of pattern deformation or surface roughening owing to stringiness on the surface of the coating film in mold peeling, and therefore the composition can form a good pattern (good imprintability).

(3) The composition is excellent in uniform coatability, and is therefore suitable to the field of application to large-size substrates and to the field of microprocessing.

(4) The composition has good mechanical properties such as photocurability, heat resistance and elasticity recovery, it is favorable for various permanent films.

(5) The composition is excellent in voltage characteristics, and is suitable for materials for electronic circuits.

For example, the curable composition for photoimprints of the invention is favorably applied to semiconductor integrated circuits and components of liquid-crystal display devices (especially to microfabrication for thin-film transistors of liquid-crystal displays, protective films of liquid-crystal color filters, spacers and other components of liquid-crystal display devices, etc.) to which, however, conventional compositions are heretofore difficult to apply; and in addition, the composition of the invention is further applicable to production of any others, widely for example, partitioning materials for plasma display panels, flat screens, microelectromechanical systems (MEMS), sensor devices, optical discs, magnetic-recording media such as high-density memory discs, optical parts such as diffraction gratings and relief holograms, nanodevices, optical devices, optical films, polarization devices, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

In the composition of the invention, the proportion of the compound having a molecular weight of at most 190 is at most 20% by mass, preferably at most 10% by mass, more preferably at most 5% by mass. The content of the low-molecular weight ingredient in the composition is reduced to that range, and therefore the patterning accuracy with the composition can be enhanced more and the volatile ingredient during the process can be reduced.

Preferably in the invention, the proportion of the compound having a molecular weight of at most 200 in the composition falls within the above-mentioned range, more preferably, the proportion of the compound having a molecular weight of at most 210 falls within the range.

The viscosity of the curable composition for photoimprints of the invention is described. Unless otherwise specifically indicated, the viscosity in the invention means a viscosity at 25° C. Preferably, the viscosity at 25° C. of the curable composition for photoimprints of the invention is from 3 to 50 mPa·s, more preferably from 3 to 30 mPa·s, even more preferably from 3 to 20 mPa·s. When the viscosity of the composition of the invention is less than 3 mPa·s, then this is problematic in point of the substrate applicability of the composition in coating and the mechanical strength of the formed film may lower. Concretely, when the viscosity is at least 3 mPa·s, then the composition is free from a trouble of coating unevenness or a trouble of flowing away from substrate in coating. The composition having a viscosity of at least 3 mPa·s is easier to produce than the composition having a viscosity of less than 3 mPa·s. On the other hand, when the viscosity of the composition of the invention is at most 50 mPa·s, then the composition may well flow into the cavity of the recesses of a mold having a micropattern thereon, even when the composition is kept in airtight contact with the mold, and therefore air is hardly taken into the cavity and the composition is free from a trouble of bubble defects. In addition, the composition residue hardly remains in the projections of the mold after photocuring. When the viscosity of the composition of the invention is more than 50 mPa·s, then the viscosity may have some negative influence on the process of micropatterning.

In general, the viscosity of the composition may be controlled by blending various monomers, oligomers and polymers having a different viscosity. For planning the viscosity of the curable composition for photoimprints of the invention so as to fall within the above-mentioned range, preferably, a monomer compound having a viscosity of from 2 to 5 mPa·s is added to control the viscosity of the composition.

### (Photopolymerizable Monomer)

The curable composition for photoimprints of the invention contains a photopolymerizable monomer. Containing a photopolymerizable monomer, the composition of the invention may attain good patterning accuracy (imprintability) after irradiation with light. In the invention, “photopolymerizable monomer” means a monomer capable of undergoing polymerization through irradiation with light to form a polymer.

The photopolymerizable monomer for use in the invention is preferably a compound having a viscosity of at most 300 mPa·s from the viewpoint of controlling the viscosity of the composition, more preferably at most 100 mPa·s, even more preferably at most 30 mPa·s.

The weight-average molecular weight of the photopolymerizable monomer in the invention is preferably at most 1000 from the viewpoint of controlling the viscosity of the composition, more preferably from 160 to 500, even more preferably from 190 to 350.

In the invention, when a monomer with little interactivity, for example, a monomer having little polarity and having a simple stereostructure is used, then the composition may have a low viscosity even though the content of the compound having a molecular weight of at most 190 is at most 20% by mass.

Preferably, the photopolymerizable monomer in the invention has a radical photopolymerizable functional group such as, for example, an ethylenic unsaturated bond-having functional group. The functional group is preferably a (meth)acrylate group, a vinyl group, an allyl group or a styryl group, more preferably a (meth)acrylate group. The composition of the invention may contain one or more photopolymerizable monomers, and the composition may additionally contain any other photopolymerizable monomer (e.g., cationic polymerizable group-having polymerizable monomer).

From the viewpoint of the mechanical properties of the cured film, preferred is use of a di- or more functional monomer.

The polyfunctional monomer necessarily has a large molecular weight, and the viscosity of the composition containing it is therefore high; and owing to the high viscosity thereof, the patterning accuracy with the composition may lower. Accordingly, the photopolymerizable monomer for use in the invention is comprehensively selected in consideration of the combination of a low-viscosity monomer to be combined with the polyfunctional monomer for imparting mechanical properties to the cured film or the combination of an oxetane compound and a functional acid anhydride in the invention.

In the curable composition for photoimprints of the invention, the content of the photopolymerizable monomer is preferably from 20 to 90% by mass, more preferably from 30 to 70% by mass, from the viewpoint of the patterning accuracy with the composition.

As the photopolymerizable monomer used in the invention, a polymerizable unsaturated monomer having one ethylenic unsaturated bond-containing group (monofunctional polymerizable unsaturated monomer) can be exemplified.

Examples of the photopolymerizable monomer include 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropanediol acrylate, 2-ethylhexyl (meth)acrylate, 2-ethylhexylcarbitol (meth) acrylate, 2-hydroxybutyl(meth)acrylate, 2-hydroxyethyl(meth)acrylate, 2-hydroxypropyl(meth)acrylate, 2-methoxyethyl(meth)acrylate, 3-methoxybutyl(meth) acrylate, 4-hydroxybutyl(meth)acrylate, acrylic acid dimer, benzyl(meth)acrylate, butanediol mono(meth)acrylate, butoxyethyl(meth)acrylate, butyl(meth)acrylate, cetyl(meth)acrylate, ethyleneoxide-modified (hereinafter this may be referred to as “EO”) cresol(meth)acrylate, dipropylene glycol(meth)acrylate, ethoxylated phenyl(meth)acrylate, ethyl(meth)acrylate, isoamyl(meth)acrylate, isobutyl(meth)acrylate, isooctyl(meth)acrylate, cyclohexyl(meth)acrylate, isobornyl(meth)acrylate, dicyclopentanyl(meth)acrylate, dicyclopentanyloxyethyl(meth)acrylate, isomyristyl(meth)acrylate, lauryl(meth)acrylate, methoxydiproylene glycol(meth)acrylate, methoxytripropylene glycol(meth)acrylate, methoxypolyethylene glycol(meth)acrylate, methoxytriethylene glycol(meth)acrylate, methyl(meth)acrylate, neopentyl glycol benzoate(meth)acrylate, nonylphenoxypolyethylene glycol(meth)acrylate, nonylphenoxypolypropylene glycol(meth)acrylate, octyl(meth)acrylate, paracumylphenoxyethylene glycol(meth)acrylate, epichlorohydrin (hereinafter referred to as “ECH”)-modified phenoxyacrylate, phenoxyethyl(meth)acrylate, phenoxydiethylene glycol(meth)acrylate, phenoxyhexaethylene glycol(meth)acrylate, phenoxytetraethylene glycol(meth)acrylate, polyethylene glycol(meth)acrylate, polyethylene glycol-polypropylene glycol(meth)acrylate, polypropylene glycol(meth)acrylate, stearyl (meth)acrylate, EO-modified succinic acid (meth)acrylate, tert-butyl(meth)acrylate, tribromophenyl(meth)acrylate, EO-modified tribromophenyl(meth)acrylate, tridodecyl(meth)acrylate, p-isopropenylphenol, styrene, α-methylstyrene, acrylonitrile, vinyl carbazole and ethyloxetanylmethyl acrylate.

Among these photopolymerizable monomers, acrylate monomers can be preferably used in the invention.

As the photopolymerizable monomer used in the invention, a difunctional polymerizable unsaturated monomer having two ethylenic unsaturated bond-containing group (difunctional polymerizable unsaturated monomer) can be also exemplified. Examples of the difunctional polymerizable unsaturated monomer include diethylene glycol monoethyl ether(meth)acrylate, dimethylol-dicyclopentane di(meth)acrylate, di(meth)acrylated isocyanurate, 1,3-butylene glycol di(meth)acrylate, 1,4-butanediol di(meth)acrylate, EO-modified 1,6-hexanediol di(meth)acrylate, ECH-modified 1,6-hexanediol di(meth)acrylate, allyloxy-polyethylene glycol acrylate, 1,9-nonanediol di(meth)acrylate, EO-modified bisphenol A di(meth)acrylate, PO-modified bisphenol A di(meth)acrylate, modified bisphenol A di(meth)acrylate, EO-modified bisphenol F di(meth)acrylate, ECH-modified hexahydrophthalic acid diacrylate, hydroxypivalic acid neopentyl glycol di(meth)acrylate, neopentyl glycol di(meth)acrylate, EO-modified neopentyl glycol diacrylate, propyleneoxide (hereinafter referred to as “PO”)-modified neopentyl glycol diacrylate, caprolactone-modified hydroxypivalate neopentyl glycol, stearic acid-modified pentaerythritol di(meth)acrylate, ECH-modified phthalic acid di(meth)acrylate, poly(ethylene glycol-tetramethylene glycol) di(meth)acrylate, poly(propylene glycol-tetramethylene glycol) di(meth)acrylate, polyester (di)acrylate, polyethylene glycol di(meth)acrylate, polypropylene glycol di(meth)acrylate, ECH-modified propylene glycol di(meth)acrylate, silicone di(meth)acrylate, triethylene glycol di(meth)acrylate, tetraethylene glycol di(meth)acrylate, tricyclodecanedimethanol diacrylate, neopentyl glycol-modified trimethylolpropane di(meth)acrylate, tripropylene glycol di(meth)acrylate, EO-modified tripropylene glycol di(meth)acrylate, triglycerol di(meth)acrylate, dipropylene glycol di(meth)acrylate, divinylethylene-urea, divinylpropylene-urea, dicyclopentenyl(meth)acrylate, dicyclopentenyloxyethyl(meth)acrylate and dicyclopentanyl di(meth)acrylate.

Of those, especially preferred for use in the invention are neopentyl glycol di(meth)acrylate, 1,9-nonanediol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, dicyclopentenyl(meth)acrylate, dicyclopentenyloxyethyl(meth)acrylate, dicyclopentanyl di(meth)acrylate etc.

As the photopolymerizable monomer in the invention, also usable is a polyfunctional polymerizable unsaturated monomer having 3 or more ethylenic unsaturated bond-containing groups. Examples of the polyfunctional polymerizable unsaturated monomer include ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxytetra(meth)acrylate, pentaerythritol(meth)acrylate, etc.

Of those, preferred for use in the invention are

EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, pentaerythritol ethoxytetra(meth)acrylate, pentaerythritol tetra(meth)acrylate, etc.

In the invention, as the photopolymerizable monomer, also usable is urethane(meth)acrylate, which includes, for example, U-2PPA, U-4HA, U-6HA, UA-100H, U-6LPA, U-15HA, UA-32P, U-324A,

U-4H, U-6H, U-108A, U-200PA, U-412A, UA-4200, UA-4400, UA-340P, UA-2235PE, UA-160TM, UA-122P, UA-5201, UA-512, UA-W2A, UA-W2, UA-7000, UA-7100, UA-7200 (all registered trademarks) available from Shin-Nakamura Chemical; and AH-600, AT-600, UA-306H, UA-306T, UA-306I, UA-510H, UF-8001G available from Kyoei-sha Chemical. In addition to these, other urethane(meth)acrylates having any desired structure can be selected for use herein.

Preferred modes of blending photopolymerizable monomers for use in the invention are described below.

The above-mentioned monofunctional polymerizable unsaturated monomer is effective for reducing the viscosity of the composition, and in general, the amount thereof to be added is within a range of from 10 to 100% by mass of all the polymerizable unsaturated monomers, preferably from 10 to 80% by mass, more preferably from 10 to 60% by mass, even more preferably from 10 to 30% by mass.

The above-mentioned monomer having two unsaturated bond-containing groups (difunctional polymerizable unsaturated monomer) is effective for enhancing the mechanical properties of the cured film, and the amount thereof to be added is preferably at least 50% by mass of all the polymerizable unsaturated monomers, more preferably at leas 60% by mass, even more preferably at least 70% by mass. Preferably containing a di- or more functional unsaturated monomer in an amount of at least 50% by mass, the composition may form a cured film having better elasticity recovery. Not specifically defined, the uppermost limit of the content may be generally at most 90% by mass.

Preferably, the composition of the invention contains at least a (meth)acrylate monomer as the photopolymerizable monomer, more preferably both a monofunctional (meth)acrylate monomer and a di- or more functional (meth)acrylate monomer, even more preferably both a monofunctional (meth)acrylate monomer and a di- or more functional (meth)acrylate monomer in which the di- or more functional (meth)acrylate monomer accounts for at least 50% by mass of all the polymerizable monomers.

### (Photopolymerization Initiator)

The curable composition for photoimprints of the invention contains a photopolymerization initiator. The molecular weight of the photopolymerization initiator used in the invention is preferably at least 170, more preferably at least 180, still more preferably at least 190. The upper limit of the molecular weight of the photopolymerization initiator is for example 1000, preferably 500.

The photopolymerization initiator is generally a radical photopolymerization initiator. The composition of the invention contains a photopolymerization initiator to initiate polymerization through irradiation with light, and therefore secures good patterning accuracy after photoirradiation. Preferably, the content of the photopolymerization initiator is, for example, from 0.1 to 15% by mass of the entire composition, more preferably from 0.2 to 12% by mass, even more preferably from 0.3 to 10% by mass. In case where two or more different types of photopolymerization initiators are in the composition, their total amount may fall within the above range.

When the proportion of the photopolymerization initiator is at least 0.1% by mass, then it is favorable since the composition tends to better in point of the sensitivity (rapid curability), the resolution, the line edge roughness reduction and the coating film strength. On the other hand, when the proportion of the photopolymerization initiator is at most 15% by mass, then it is also favorable since the composition tends to better in point of the light transmittance, the discoloration resistance and the handlability.

The photopolymerization initiator for use in the invention includes those active to the wavelength of the light source to be used, for which, for example, usable are those capable of generating suitable active species.

As the radical photopolymerization initiator for use in the invention, for example, commercial products may be used.

Their examples are Irgacure® 2959 (1-[4-(2-hydroxyethoxy)phenyl]-2-hydroxy-2-methyl-1-propan-1-one), Irgacure® 184 (1-hydroxycyclohexyl phenyl ketone), Irgacure® 500 (1-hydroxycyclohexyl phenyl ketone, benzophenone), Irgacure® 651 (2,2-dimethoxy-1,2-diphenylethan-1-one), Irgacure® 369 (2-benzyl-2-dimethylamino-1-(4-morpholinophenyl)butanone-1), Irgacure® 907 (2-methyl-1[4-methylthiophenyl]-2-morpholinopropan-1-one), Irgacure® 819 (bis(2,4,6-trimethylbenzoyl)-phenylphosphine oxide), Irgacure® 1800 (bis(2,6-dimethoxybenzoyl)-2,4,4-trimethylpentylphosphine oxide, 1-hydroxycyclohexyl phenyl ketone), Irgacure® 1800 (bis(2,6-dimethoxybenzoyl)-2,4,4-trimethylpentylphosphine oxide, 2-hydroxy-2-methyl-1-phenyl-1-propan-1-one), Irgacure® OXE01 (1,2-octanedione, 1-[4-(phenylthio)phenyl]-2-(O-benzoyloxime)), Darocur® 1116, 1398, 1174 and 1020, CGI242 (ethanone, 1-[9-ethyl-6-(2-methylbenzoyl)-9H-carbazol-3-yl]-1-(O-acetyloxime)), which are all available from Ciba; Lucirin TPO (2,4,6-trimethylbenzoyldiphenylphosphine oxide), Lucirin TPO-L (2,4,6-trimethylbenzoylphenylethoxyphosphine oxide) which are both available from BASF; Esacure 1001M (1-[4-benzoylphenylsulfanyl]phenyl)-2-methyl-2-(4-methylphenylsulfonyl)propan-1-one available from Nihon SiberHegner; Adeka Optomer® N-1414 (carbazole/phenone compound), Adeka Optomer® N-1717 (acridine compound), Adeka Optomer® N-1606 (triazine compound), all available from Asahi Denka; Sanwa Chemical's TFE-triazine (2-[2-(furan-2-yl)vinyl]-4,6-bis(trichloromethyl)-1,3,5-triazine), Sanwa Chemical's TME-triazine (2-[2-(5-methylfuran-2-yl)vinyl]-4,6-bis(trichloromethyl)-1,3,5-triazine), Sanwa Chemical's MP-triazine (2-(4-methoxyphenyl)-4,6-bis(trichloromethyl)-1,3,5-triazine); Midori Chemical's TAZ-113 (2-[2-(3,4-dimethoxyphenyl)ethenyl]-4,6-bis(trichloromethyl)-1,3,5-triazine), Midori Chemical's TAZ-108 (2-(3,4-dimethoxyphenyl)-4,6-bis(trichloromethyl)-1,3,5-triazine; as well as benzophenone, 4,4′-bisdiethylaminobenzophenone, methyl-2-benzophenone, 4-benzoyl-4′-methyldiphenyl sulfide, 4-phenylbenzophenone, ethyl Michler's ketone, 2-chlorothioxanthone, 2-methylthioxanthone, 2-isopropylthioxanthone, 4-isopropylthioxanthone, 2,4-diethylthioxanthone, 1-chloro-4-propoxythioxanthone, 2-methylthioxanthone, thioxanthone ammonium salt, benzoin, 4,4′-dimethoxybenzoin, benzoin methyl ether, benzoin ethyl ether, benzoin isopropyl ether, benzoin isobutyl ether, benzyl dimethyl ketal, 1,1,1-trichloroacetophenone, diethoxyacetophenone, dibenzosuberone, methyl o-benzoylbenzoate, 2-benzoylnaphthalene, 4-benzoylbiphenyl, 4-benzoyldiphenyl ether, 1,4-benzoylbenzene, benzil, 10-butyl-2-chloroacridone, [4-(methylphenylthio)phenyl]phenylmethane), 2-ethylanthraquinone, 2,2-bis(2-chlorophenyl)-4,5,4′,5′-tetrakis(3,4,5-trimethoxyphenyl)-1,2′-biimidazole, 2,2-bis(o-chlorophenyl)-4,5,4′,5′-tetraphenyl-1,2′-biimidazole, tris(4-dimethylaminophenyl)methane, ethyl 4-(dimethylamino)benzoate, 2-(dimethylamino)ethyl benzoate, butoxyethyl 4-(dimethylamino)benzoate, etc.

### (Antioxidant)

The curable composition for photoimprints of the invention preferably contains an antioxidant. The content of the antioxidant to be in the composition of the invention is, for example, from 0.01 to 10% by mass of the total amount of composition, preferably from 0.2 to 5% by mass. When two or more different types of antioxidants are in the composition, the total amount thereof falls within the above range.

The antioxidant is for preventing fading by heat or photoirradiation, and for preventing fading by various oxidizing gases such as ozone, active hydrogen, NOx, SOx (x is an integer), etc. Especially in the invention, the antioxidant added to the composition brings about the advantage that the cured film is prevented from being discolored and the film thickness is prevented from being reduced through decomposition. The antioxidant includes hydrazides, hindered amine-type antioxidants, nitrogen-containing heterocyclic mercapto compounds, thioether-type antioxidants, hindered phenol-type antioxidants, ascorbic acids, zinc sulfate, thiocyanates, thiourea derivatives, saccharides, nitrites, sulfites, thiosulfates, hydroxylamine derivatives, etc. Of those, preferred are hindered phenol-type antioxidants and thioether-type antioxidants from the viewpoint of their effect of preventing cured film discoloration and preventing film thickness reduction.

Commercial products of the antioxidant usable herein include Irganox 1010, 1035FF, 1076, 1222 (all by Ciba-Geigy); Antigene P, 3C, FR, Sumilizer S, Sumilizer GA80 (by Sumitomo Chemical); Adekastab AO70, AO80, AO503, LA52, LA57, LA62, LA63, LA67, LA68LD, LA77 (by Adeka), etc. These may be used either singly or as combined.

### (Surfactant)

The curable composition for photoimprints of the invention may contain a surfactant. The content of the surfactant that may be in the composition may be, for example, from 0.001 to 5% by mass of the total amount of the composition, preferably from 0.002 to 4% by mass, more preferably from 0.005 to 3% by mass. In case where two or more different types of surfactants are in the composition, the total amount thereof falls within the above range. When the surfactant content in the composition is from 0.001% to 5% by mass, then the coating uniformity of the composition can be good and it is unlikely to worsen the mold transferability due to excessive amount of surfactant.

As the surfactant, preferably, the composition contains at least one of a fluorine-containing surfactant, a silicone-type surfactant and a fluorine-containing silicone-type surfactant, more preferably contains both of a fluorine-containing surfactant and a silicone-type surfactant, or contains a fluorine-containing silicone-type surfactant, most preferably contains a fluorine-containing silicone-type surfactant. Nonionic surfactants are preferable as the fluorine-containing surfactant and the silicone-type surfactant.

The fluorine-containing silicone-type surfactant as referred to herein means a surfactant satisfying both the requirement of a fluorine-containing surfactant and that of a silicone-type surfactant.

Using the surfactant of the type may solve the problem of coating failures such as striation and flaky pattern formation (drying unevenness of resist film) that may occur when the curable composition for photoimprints of the invention is applied onto substrates on which various films are formed, for example, onto silicon wafers in semiconductor production, or onto glass square substrates, chromium films, molybdenum films, molybdenum alloy films, tantalum films, tantalum alloy films, silicon nitride films, amorphous silicon films, tin oxide-doped indium oxide (ITO) films or tin oxide films in production of liquid-crystal devices. In addition, the surfactant is effective for enhancing the flowability of the composition of the invention in the cavity of the concave part of mold, for enhancing the mold-resist releasability, for enhancing the resist adhesiveness to substrates, and for lowering the viscosity of the composition. When the surfactant is added to the curable composition for photoimprints of the invention, then the coating uniformity of the composition is remarkably improved and the composition obtains excellent coating property at the coating by a spin coater and a slit scan coater regardless of size of a substrate.

Examples of the nonionic fluorine-containing surfactant usable in the invention include Fluorad FC-430, FC-431 (Sumitomo 3M's trade names); Surflon S-382 (Asahi Glass's trade name); EFTOP EF-122A, 122B, 122C, EF-121, EF-126, EF-127, MF-100 (Tochem Products' trade names); PF-636, PF-6320, PF-656, PF-6520 (OMNOVA Solution's trade names); Futagent FT250, FT251, DFX18 (Neos' trade names); Unidyne DS-401, DS-403, DS-451 (Daikin's trade names); Megafac 171, 172, 173, 178K, 178A (Dai-Nippon Ink's trade names).

Examples of the nonionic silicone-type surfactant include SI-10 series (Takemoto Yushi's trade name), Megafac Paintad 31 (Dai-Nippon Ink's trade name), KP-341 (Shin-Etsu Chemical's trade name).

Examples of the fluorine-containing silicone-type surfactant include X-70-090, X-70-091, X-70-092, X-70-093 (Shin-Etsu Chemical's trade names); Megafac R-08, XRB-4 (Dai-Nippon Ink's trade names).

### (Other Ingredients)

In addition to the above-mentioned ingredients, the composition of the invention may contain, if desired, nonpolymerizable molecule, polymer component, release agent, organimetallic coupling agent, polymerization inhibitor, UV absorbent, light stabilizer, antiaging agent, plasticizer, adhesion promoter, thermal polymerization initiator, photobase generator, colorant, elastomer particles, photosensitizer, basic compound and additionally flowability promoter, defoaming agent, dispersant, etc.

The nonpolymerizable compound can be added to the composition of the invention to enhance its fittability and control the properties of the cured film. The content of the nonpolymerizable compound is determined so that the content of the photopolymerizable molecules can be controlled in the range of the invention. Examples of the nonpolymerizable compound include alkylester such as dioctyl sebacinate, thiourea compound, organic particles, inorganic particles, etc.

For the purpose of further enhancing the releasability thereof, the composition of the invention may contain a release agent. Concretely, the release agent is added to the composition for the purpose of smoothly releasing the mold pressed to the layer of the composition of the invention not causing surface roughening of the resin layer and not deforming the pattern formed on the layer. The release agent may be any known release agent, including, for example, silicone release agents, solid waxes such as polyethylene wax, amide wax, Teflon® powder, etc., as well as fluorine-containing compounds, phosphate compounds, etc. The release agent may be previously applied to the surface of a mold.

A silicone release agent exhibits especially good mold releasability when combined with the above-mentioned photocurable resin for use in the invention, hardly causing pattern deformation in mold releasing. The silicone release agent has a basic structure of an organopolysiloxane structure, including, for example, native or denatured silicone oil, trimethylsiloxysilicic acid-containing polysiloxane, silicone-type acrylic resin, etc. Ordinary silicone-type leveling agent generally used in hard coat compositions is also usable herein.

Denatured silicone oil is one produced by denaturing the side branch and/or the terminal of polysiloxane, and is grouped into reactive silicone oil and non-reactive silicone oil. The reactive silicone oil includes amino-modified, epoxy-modified, carboxyl-modified, carbinol-modified, methacryl-modified, mercapto-modified, phenol-modified, semiterminal-modified, heterofunctional group-modified ones. The non-reactive silicone oil includes polyether-modified, methylstyryl-modified, alkyl-modified, higher fatty ester-modified, hydrophilic specific-modified, higher alkoxy-modified, higher fatty acid-modified, fluorine-modified ones.

One polysiloxane molecule may have two or more of the above-mentioned denaturation modes.

Preferably, the denatured silicone oil has suitable compatibility with the constitutive ingredients of the composition of the invention. In particular, in case where a reactive silicone oil that is reactive with the optional constitutive ingredients in the composition of the invention is used in the composition, it may be fixed by chemical bonding in the cured film of the composition, and therefore it may be free from a problem of worsening the adhesiveness of the cured film and from other problems of contamination and degradation of the cured film. In particular, the reactive silicone oil is effective for enhancing the adhesiveness to the vapor-deposition film in an evaporation step. A silicone modified with a photocurable functional group, such as a (meth)acryloyl-modified silicone, a vinyl-modified silicone or the like, may crosslink with the constitutive ingredients of the composition of the invention, and therefore it may enhance the properties of the cured film.

A trimethylsiloxysilicic acid-containing polysiloxane may readily bleed out on the surface of the composition and therefore brings about excellent releasability. In addition, even though it bleeds out on the surface, the polysiloxane of the type still keeps good adhesiveness and is excellent in adhesiveness to a metal-deposition layer and an overcoat layer, and therefore it is favorable for use herein.

One or more different types of the above-mentioned release agents may be used herein either singly or as combined.

In case where the release agent is added to the curable composition for photoimprints of the invention, its content is preferably from 0.001 to 10% by mass of the total amount of the composition, more preferably from 0.01 to 5% by mass . When the proportion of the release agent is from 0.001 to 10% by mass, then the mold releasability of the layer of the curable composition for photoimprints of the invention is improved and it can prohibit cause of a problem of surface roughening of the coating layer as the composition may be repelled in coating, and can prohibit cause of other problems of worsening the adhesiveness of the composition to substrates themselves or to adjacent layers such as deposit layers in the products or breaking the coating film in transferring (as the film strength is too weak).

The composition of the invention may contain an organic metal coupling agent added thereto, for the purpose of enhancing the heat resistance and the strength of the micropatterned surface structure of the layer of the composition and for enhancing the adhesiveness of the layer to metal deposition layers. The organic metal coupling agent is effective, as having the effect of promoting the thermosetting reaction of the composition. As the organic metal coupling agent, herein usable are various coupling agents such as a silane coupling agent, a titanium coupling agent, a zirconium coupling agent, an aluminum coupling agent, a tin coupling agent, etc.

The silane coupling agent for use in the composition of the invention includes, for example, vinylsilanes such as vinyltrichlorosilane, vinyltris(β-methoxyethoxy)silane, vinyltriethoxysilane, vinyltrimethoxysilane, etc.; γ-methacryloxypropyltrimethoxysilane; epoxysilanes such as β-(3,4-epoxycyclohexyl)ethyltrimethoxysilane, γ-glycidoxypropyltrimethoxysilane, γ-glycidoxypropylmethyldiethoxysilane, etc.; aminosilanes such as N-β-(aminoethyl)-γ-aminopropyltrimethoxysilane, N-β-(aminoethyl)-γ-aminopropylmethyldimethoxysilane, γ-aminopropyltrimethoxysilane, N-phenyl-γ-aminopropyltrimethoxysilane, etc.; and other silane coupling agents such as γ-mercaptopropyltrimethoxysilane, γ-chloropropylmethyldimethoxysilane, γ-chloropropylmethyldiethoxysilane, etc.

The titanium coupling agent includes, for example, isopropyltriisostearoyl titanate, isopropyltridecylbenzenesulfonyl titanate, isopropyltris(dioctylpyrophosphate)titanate, tetraisopropylbis(dioctylphosphite)titanate, tetraoctylbis(ditridecylphosphite)titanate, tetra(2,2-diallyloxymethyl)bis(ditridecyl)phosphite titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropylisostearoyldiacryl titanate, isopropyltri(dioctylphosphate)titanate, isopropyltricumyl titanate, isopropyltri(N-aminoethyl-aminoethyl)titanate, dicumylphenyloxyacetate titanate, diisostearoylethylene titanate, etc.

The zirconium coupling agent includes, for example, tetra-n-propoxy zirconium, tetra-butoxy zirconium, zirconium tetraacetylacetate, zirconium dibutoxybis(acetylacetonate), zirconium tributoxyethyl acetacetate, zirconium butoxyacetylacetonate bis(ethylacetacetate), etc.

The aluminum coupling agent includes, for example, aluminum isopropylate, mono-sec-butoxyaluminium diisopropylate, aluminum sec-butyrate, aluminum ethylate, ethylacetacetate aluminum diisopropylate, aluminum tris(ethylacetacetate), alkylacetacetate aluminum diisopropylate, aluminum monoacetylacetonate bis(ethylacetacetate), aluminum tris(acetylacetate), etc.

The above-mentioned organic metal coupling agent maybe in the curable composition for photoimprint in an amount falling within a range of from 0.001 to 10% by mass of the total solid content of the composition. When the proportion of the organic metal coupling agent is at least 0.001% by mass, then it may be more effective for enhancing the heat resistance, the strength and the adhesiveness to deposition layers of the cured film. On the other hand, when the proportion of the organic metal coupling agent is at most 10% by mass, then it is favorable since the composition may be stabilized and may have good film formability.

A polymerization inhibitor may be incorporated in the curable composition for photoimprints of the invention for the purpose of enhancing the storage stability of the composition. The polymerization inhibitor includes, for example, phenols such as hydroquinone, tert-butylhydroquinone, catechol, hydroquinone monomethyl ether; quinones such as benzoquinone, diphenylbenzoquinone; phenothiazines; cupper compounds, etc. Preferably, the polymerization inhibitor is incorporated in the composition optionally in an amount of from 0.001 to 10% by mass of the entire amount of the composition.

A UV absorbent may be incorporated in the curable composition for photoimprints of the invention. Commercial products of UV absorbent usable herein include Tinuvin P, 234, 320, 326, 327, 328, 213 (all by Ciba-Geigy), Sumisorb 110, 130, 140, 220, 250, 300, 320, 340, 350, 400 (all by Sumitomo Chemical

Industry), etc. Preferably, the UV absorbent is in the curable composition for photoimprint lithography in an amount falling within a range of from 0.01 to 10% by mass of the total amount of the composition.

A light stabilizer may be incorporated in the curable composition for photoimprints of the invention. Commercial products of light stabilizer usable herein include Tinuvin 292, 144, 622 LD (all by Ciba-Geigy), Sanol LS-770, 765, 292, 2626, 1114, 744 (all by Sankyo Chemical Industry), etc. Preferably, the light stabilizer is in the composition in an amount falling within a range of from 0.01 to 10% by mass of the total amount of the composition.

An antiaging agent may be incorporated in the curable composition for photoimprints of the invention. Commercial products of antiaging agent usable herein include Antigene W, S, P, 3C, 6C, RD-G, FR, AW (all by Sumitomo Chemical Industry), etc. Preferably, the antiaging agent is in the composition in an amount falling within a range of from 0.01 to 10% by mass of the total amount of the composition.

A plasticizer may be added to the curable composition for photoimprints of the invention for the purpose of controlling the adhesiveness of the composition to substrate, and the flexibility and the hardness of the formed film, etc. Preferred examples of the plasticizer include, for example, dioctyl phthalate, didodecyl phthalate, triethylene glycol dicaprylate, dimethylglycol phthalate, tricresyl phosphate, dioctyl adipate, dibutyl sebacate, triacetylglycerine, dimethyl adipate, diethyl adipate, di(n-butyl)adipate, dimethyl suberate, diethyl suberate, di(n-butyl)suberate, etc. The plasticizer may be in the composition in an amount of at most 30% by mass of the composition. Preferably, the amount is at most 20% by mass, more preferably at most 10% by mass. In order that the plasticizer could exhibit the desired effect thereof, its amount is preferably at least 0.1% by mass.

An adhesiveness promoter may be added to the curable composition for photoimprints of the invention for the purpose of controlling the adhesiveness of the composition to substrate. The adhesiveness promoter includes benzimidazoles, polybenzimidazoles, lower hydroxyalkyl-substituted pyridine derivatives, nitrogen-containing heterocyclic compounds, urea or thiourea, organic phosphorous compounds, 8-hydroxyquinoline, 4-hydroxypteridine, 1,10-phenanthroline, 2,2′-bipyridine derivatives, benzotriazoles, organic phosphorus compounds, phenylenediamine compounds, 2-amino-1-phenylethanol, N-phenylethanolamine, N-ethyldiethanolamine, N-ethyldiethanolamine, N-ethylethanolamine and its derivatives, benzothiazole derivatives, etc. The adhesiveness promoter may be in the composition preferably in an amount of at most 20% by mass of the composition, more preferably at most 10% by mass, even more preferably at most 5% by mass. For attaining the effect of the adhesiveness promoter, the amount thereof is preferably at least 0.1% by mass.

In case where the composition of the invention is cured, a thermal polymerization initiator may be added thereto, if desired. Preferred examples of the thermal polymerization initiator include, for example, peroxides and azo compounds. Specific examples of the compounds are benzoyl peroxide, tert-butyl peroxybenzoate, azobisisobutyronitrile, etc. The thermal polymerization .initiator may be in the composition preferably in an amount of at most 8.0% by mass of the composition, more preferably at most 6.0% by mass, even more preferably at most 4.0% by mass. For attaining the effect of the thermal polymerization initiator, the amount thereof is preferably at least 3.0% by mass.

A photobase generator may be added, if desired, to the curable composition for photoimprints of the invention for the purpose of controlling the patterning profile and the sensitivity of the composition. Preferred examples of the photobase generator include 2-nitrobenzylcyclohexyl carbamate, triphenylmethanol, O-carbamoylhydroxylamide, O-carbamoyl oxime, [[(2,6-dinitrobenzyl)oxy]carbonyl]cyclohexylamine, bis[[(2-nitrobenzyl)oxy]carbonyl]hexane-1,6-diamine, 4-(methylthiobenzoyl)-1-methyl-1-morpholinoethane, (4-morpholinobenzoyl)-1-benzyl-1-dimethylaminopropane, N-(2-nitrobenzyloxycarbonyl)pyrrolidine, hexaammine-cobalt(III)tris(triphenylmethyl borate), 2-benzyl-2-dimethylamino-1-(4-morpholinophenyl)-butanone, 2,6-dimethyl-3,5-diacetyl-4-(2′-nitrophenyl)-1,4-dihydropyridine, 2,6-dimethyl-3,5-diacetyl-4-(2′,4′-dinitrophenyl)-1,4-dihydropyridine, etc.

A colorant may be optionally added to the curable composition for photoimprints of the invention for the purpose of enhancing the visibility of the coating film. As the colorant, herein usable are pigments and dyes that are used in UV inkjet compositions, color filter compositions, CCD image sensor compositions and the like, not detracting from the object of the invention. The pigments usable in the invention may be various known inorganic pigments and organic pigments. The inorganic pigments include metal compounds such as metal oxides, metal complexes and others, concretely iron, cobalt, aluminum, cadmium, lead, copper, titanium, magnesium, chromium, zinc, antimony and the like metal oxides, metal composite oxides, etc. Examples of the organic pigments include C.I. Pigment Yellow 11, 24, 31, 53, 83, 99, 108, 109, 110, 138, 139, 151, 154, 167, C.I. Pigment Orange 36, 38, 43, C.I. Pigment Red 105, 122, 149, 150, 155, 171, 175, 176, 177, 209, C.I. Pigment Violet 19, 23, 32, 39, C.I. Pigment Blue 1, 2, 15, 16, 22, 60, 66, C.I. Pigment Green 7, 36, 37, C.I. Pigment Brown 25, 28, C.I. Pigment Black 1, 7 and carbon black. Preferably, the colorant may be in the composition in an amount of from 0.001 to 2% by mass of the total amount of the composition.

As still another optional ingredient, elastomer particles may be added to the curable composition for photoimprints of the invention for the purpose of enhancing the mechanical strength and the flexibility of the cured film.

The elastomer particles capable of being optionally added to the curable composition for photoimprints of the invention preferably have a mean particle size of from 10 nm to 700 nm, more preferably from 30 to 300 nm. For example, the elastomer particles are of polybutadiene, polyisoprene, butadiene/acrylonitrile copolymer, styrene/butadiene copolymer, styrene/isoprene copolymer, ethylene/propylene copolymer, ethylene/α-olefin copolymer, ethylene/α-olefin/polyene copolymer, acrylic rubber, butadiene/(meth)acrylate copolymer, styrene/butadiene block copolymer, styrene/isoprene block copolymer, etc. Also usable are core/shell particles prepared by coating these elastomer particles with methyl methacrylate polymer, methyl acrylate/glycidyl methacrylate copolymer or the like. The elastomer particles may have a crosslinked structure.

Commercial products of elastomer particles usable herein are, for example, Resinous Bond RKB (by Resinous Chemical), Techno MBS-61, MBS-69 (by Techno Polymer), etc.

One or more different types of these elastomer particles may be in the composition of the invention either singly or as combined. The content of the elastomer particles in the composition may be preferably from 1 to 35% by mass, more preferably from 2 to 30% by mass, even more preferably from 3 to 20% by mass.

Further, in addition to the radical photopolymerization initiator thereto, a photosensitizer may also be added to the curable composition for photoimprints of the invention for regulating the UV-region wavelength to which the composition is sensitive. Typical sensitizers usable in the invention are disclosed in J. V. Crivello, Adv. in Polymer Sci., 62, 1 (1984), concretely including pyrene, perylene, acridine orange, thioxanthone, 2-chlorothioxanthone, benzoflavin, N-vinylcarbazole, 9,10-dibutoxyanthracene, anthraquinone, coumarin, ketocoumarin, phenanthrene, camphorquinone, phenothiazine derivatives, etc.

A basic compound may be optionally added to the composition of the invention for the purpose of preventing the composition from shrinking in curing and for enhancing the thermal stability of the composition. The basic compound includes amines, nitrogen-containing heterocyclic compounds such as quinoline, quinolidine, etc., and basic alkali metal compounds, basic alkaline earth metal compounds, etc. Of those, preferred are amines from the viewpoint of the compatibility thereof with photopolymerizable monomers; and for example, they include octylamine, naphthylamine, xylenediamine, dibenzylamine, diphenylamine, dibutylamine, dioctylamine, dimethylaniline, quinuclidine, tributylamine, trioctylamine, tetramethylethylenediamine, tetramethyl-1,6-hexamethylenediamine, hexamethylenetetramine, triethanolamine, etc.

A chain transfer agent may be added to the composition of the invention for enhancing the photocurability of the composition. Concretely, the agent includes 4-bis(3-mercaptobutyryloxy)butane, 1,3,5-tris(3-mercaptobutyloxyethyl)-1,3,5-triazine-2,4,6-(1H,3H,5H)-trione, pentaerythritol tetrakis(3-mercaptobutyrate).

A solvent may be used in the curable composition for photoimprints of the invention. Preferably, the content of the organic solvent in the composition of the invention is at most 3% by mass of the total composition. Specifically, since the composition of the invention preferably contains a specific monofunctional and/or difunctional monomer as a reactive diluent, the composition does not always require an organic solvent for dissolving the constitutive ingredients therein. The content of the organic solvent in the composition of the invention is preferably at most 3% by mass, more preferably at most 2% by mass, and even more preferably, the composition contains no solvent. To that effect, the composition of the invention does not always contain an organic solvent; however, in case where the composition comprises compounds insoluble in the reactive diluent therein or in case where the viscosity of the composition is delicately controlled, an organic solvent may be optionally added to the composition. The organic solvent favorable for use in the composition of the invention may be any one generally used in ordinary curable compositions for imprints or in photoresists. Not specifically defined, therefore, the organic solvent may be any one capable of uniformly dissolving and dispersing the constitutive ingredients of the composition of the invention but not reacting with those ingredients.

The organic solvent includes, for example, alcohols such as methanol, ethanol, etc.; ethers such as tetrahydrofuran, etc.; glycol ethers such as ethylene glycol monomethyl ether, ethylene glycol dimethyl ether, ethylene glycol methylethyl ether, ethylene glycol monoethyl ether, etc.; ethylene glycol alkyl ether acetates such as methyl cellosolve acetate, ethyl cellosolve acetate, etc.; diethylene glycols such as diethylene glycol monomethyl ether, diethylene glycol diethyl ether, diethylene glycol dimethyl ether, diethylene glycol ethylmethyl ether, diethylene glycol monomethyl ether, diethylene glycolmonobutyl ether, etc.; propylene glycol alkyl ether acetates such as propylene glycol methyl ether acetate, propylene glycol ethyl ether acetate, etc.; aromatic hydrocarbons such as toluene, xylene, etc.; ketones such as acetone, methyl ethyl ketone, methyl isobutyl ketone, cyclohexanone, 4-hydroxy-4-methyl-2-pentanone, 2-heptanone, etc.; esters such as ethyl 2-hydroxypropionate, methyl 2-hydroxy-2-methylpropionate, ethyl 2-hydroxy-2-methylpropionate, ethyl hydroxyacetate, ethyl hydroxyacetate, methyl 2-hydroxy-2-methylbutanoate, methyl 3-methoxypropionate, ethyl 3-methoxypropionate, methyl 3-ethoxypropionate, ethyl 3-ethoxypropionate, ethyl acetate, butyl acetate, methyl lactate, ethyl lactate, other lactates, etc.

In addition, a high-boiling-point solvent may also be added to the composition; and the solvent includes N-methylformamide, N,N-dimethylformamide, N-methylformanilide, N-methylacetamide, N,N-dimethylacetamide, N-methylpyrrolidone, dimethyl sulfoxide, benzyl ethyl ether, dihexyl ether, acetonylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, phenyl cellosolve acetate, etc. One or more of these solvents may be in the composition of the invention either singly or as combined.

Of those, especially preferred are methoxypropylene glycol acetate, ethyl 2-hydroxypropionate, methyl 3-methoxypropionate, ethyl 3-ethoxypropionate, ethyl lactate, cyclohexanone, methyl isobutyl ketone, 2-heptanone, etc.

Preferably, the curable composition for photoimprints of the invention has a surface tension falling within a range of from 18 to 30 mN/m, more preferably from 20 to 28 mN/m. When the surface tension of the composition falls within the range, then the cured film may have good surface smoothness.

The water content of the curable composition for photoimprints of the invention in its preparation is preferably at most 2.0% by mass, more preferably at most 1.5% by mass, even more preferably at most 1.0% by mass. When the water content of the composition in its preparation is at most 2.0% by mass, then the storage stability of the composition may be bettered.

### [Production Method for Cured Product]

A method for producing a cured product (especially micropattern) using the curable composition for photoimprints of the invention is described below. The method comprises applying a curable composition for photoimprints of the invention onto a substrate or substrate (base) to form a patterning layer thereon; pressing a mold against the surface of the patterning layer; and irradiating the patterning layer with light, thereby curing the composition of the invention to form a micropattern. Especially in the invention, for the purpose of increasing the hardness of the cured product, the method preferably includes an additional step of heating the patterning layer after photoirradiation. Specifically, the curable composition for photoimprints of the invention is preferably cured by light and heat.

The cured product obtained according to the production method of the invention is excellent in the patterning accuracy, the curability and the light transmittance, and is therefore especially favorable for protective films for liquid-crystal color filters, spacers, and other constitutive members of liquid-crystal display devices.

Concretely, a patterning layer comprising at least a composition of the invention is applied to a substrate (base or support) and optionally heated to form a layer (patterning layer) thereon to produce a pattern receptor (having a patterning layer formed on a substrate), then a mold is pressed against the surface of the patterning layer of the pattern receptor and the mold pattern is transferred onto the layer, and thereafter the micropatterning layer is cured through photoirradiation or heating. The photoirradiation and heating may be repeated more than once. Photoimprint lithography according to the patterning method (production method for cured product) of the invention may be modified with lamination or multi-patterning, and may be combined with ordinary thermal imprinting.

An application mode of the curable composition for photoimprints of the invention comprises applying the composition of the invention to a substrate or a support, then exposing the layer of the composition to light, curing it and optionally baking it to produce a permanent layer such as an overcoat layer or an insulation film.

In a permanent film (resist for structural members) for use in liquid-crystal displays (LCD), it is desirable that the resist is prevented as much as possible from being contaminated with ionic impurities of metals or organic substances so as not to interfere with the performance of the display; and the concentration of the impurities is preferably at most 1000 ppm, more preferably at most 100 ppm.

A production method for a cured product using the curable composition for photoimprints of the invention (patterning method, pattern transferring method) is described concretely hereinunder.

In the production method for a cured product of the invention, first the composition of the invention is applied onto a substrate to form a patterning layer thereon.

The curable composition for photoimprints of the invention may be applied onto a substrate in any well-known method, for example, a dip coating method, an air knife coating method, a curtain coating method, a wire bar coating method, a gravure coating method, an extrusion coating method, a spin coating method, a slit scanning method or the like. The thickness of the patterning layer formed of the composition of the invention may vary depending on the use thereof, and may be from 0.05 μm to 30 μm. The composition of the invention may be used in multi-stage coating. Other organic layer such as a leveling layer and the like may be formed between the substrate and the patterning layer made of the composition of the invention whereby adhesion of dusts on the substrate and damage of the substrate can be prevented since the patterning layer is not in direct contact with the substrate. Not specifically defined, the substrate on which the composition of the invention is coated may be any of quartz, glass, optical film, ceramic material, vapor deposition film, magnetic film, reflective film, metal substrate of Ni, Cu, Cr, Fe or the like, paper, SOG, polymer substrate such as polyester film, polycarbonate film, polyimide film or the like, TFT array substrate, PDP electrode plate, glass or transparent plastic substrate, electroconductive substrate of ITO, metal or the like, insulating substrate, semiconductor substrate such as silicon, silicon nitride, polysilicon, silicon oxide, amorphous silicon or the like. The shape of the substrate may be tabular or roll.

Next, in the production method for a cured product of the invention, a mold is pressed against the surface of the patterning layer for transferring the mold pattern onto the patterning layer. Accordingly, the micropattern previously formed on the pressing surface of the mold is transferred onto the patterning layer.

In the photoimprint lithography with the curable composition for photoimprints of the invention, a light-transmissive material is selected for at least one of the mold material and/or the substrate. In the photoimprint lithography applied to the invention, the curable composition for photoimprints of the invention is applied onto a substrate to form a patterning layer thereon, and a light-transmissive mold is pressed against the surface of the layer, then this is irradiated with light from the back of the mold and the patterning layer is thereby cured. Alternatively, the curable composition for photoimprints is applied onto a light-transmissive substrate, then a mold is pressed against it, and this is irradiated with light from the back of the substrate whereby the curable composition for photoimprints can be cured.

The photoirradiation may be attained while the mold is kept in contact with the layer or after the mold is released.

In the invention, preferably, the photoirradiation is attained while the mold is kept in contact with the patterning layer.

The mold usable in the invention has a transferable pattern formed thereon. The pattern of the mold may be formed, for example, through photolithography, electronic beam lithography or the like by which a pattern may be formed to a desired processing accuracy. In the invention, however, the mold patterning method is not specifically defined.

Not specifically defined, the light-transmissive mold material for use in the invention may be anyone having a desired strength and durability. Concretely, its examples include glass, quartz, light-transparent resin such as PMMA or polycarbonate resin, transparent metal deposition film, flexible film of polydimethylsiloxane or the like, photocured film, metal film, etc.

The non-light-transmissive mold to be used with the transparent substrate in the invention is used is not also specifically defined and may be any one having a predetermined strength. Concretely, examples of the mold material include ceramic material, deposition film, magnetic film, reflective film, metal material of Ni, Cu, Cr, Fe or the like, as well as SiC, silicon, silicon nitride, polysilicon, silicon oxide, amorphous silicon, etc. However, these are not limitative. The shape of the mold is not also specifically defined, and may be any of a tabular mold or a roll mold. The roll mold is used especially when continuous transfer in patterning is desired.

The mold used in the production method of the cured product of the invention maybe subjected to release treatment for the purpose of further enhancing the releasability of the curable composition for photoimprint of the invention from the surface of the mold. Such a mold includes, for example, a mold treated by a silicone-based, fluorine-based, or other type of silane coupling agent. For example, commercial release agents such as Optool DSX manufactured by Daikin Industries, Ltd., Novec EGC-1720 manufactured by Sumitomo 3M Limited, and the like can be suitably used.

In case where the photoimprint lithography is performed using the composition of the invention, the production method of cured product of the invention is generally preferably performed at a mold pressure of 10 atom or less. By setting the mold pressure at 10 atom or less, the mold and the substrate become hard to deform and the patterning accuracy tends to increase. Furthermore, since the applied pressure is low, the device tends to be small-sized and thereby preferable. The mold pressure is preferably determined so that the residual film of the curable composition for photoimprints in the mold projections is reduced, and thus the uniformity in the mold transfer is ensured.

In the production method of cured product of the invention, the dose of photoirradiation in the step of irradiating the patterning layer with light may be sufficiently larger than the dose necessary for curing. The dose necessary for curing may be suitably determined depending on the degree of consumption of the unsaturated bonds in the composition for imprints and on the tackiness of the cured film as previously determined.

In the photoimprint lithography applied to the invention, the substrate temperature in photoirradiation may be room temperature; however, the photoirradiation may be attained under heat for enhancing the reactivity. In the previous stage of photoirradiation, preferably, the system is kept in vacuum as effective for preventing contamination with bubbles or contamination with oxygen or for preventing the reduction in reactivity, and as effective for enhancing the adhesiveness of the composition for imprints with mold. The system may be subjected to photoirradiation while still kept in vacuum. In the patterning method of the invention, the vacuum degree in photoirradiation is preferably from 10⁻¹ Pa to ordinary pressure.

Light to be used for photoirradiation to cure the curable composition for photoimprints of the invention is not specifically defined. For example, it includes light and irradiations with a wavelength falling within a range of high-energy ionizing radiation, near-ultraviolet, far-ultraviolet, visible, infrared, etc. The high-energy ionizing radiation source includes, for example, accelerators such as Cockcroft accelerator, Handegraf accelerator, linear accelerator, betatoron, cyclotron, etc. The electron beams accelerated by such an accelerator are used most conveniently and most economically; but also are any other radioisotopes and other radiations from nuclear reactors, such as γ rays, X rays, α rays, neutron beams, proton beams, etc. The UV sources include, for example, UV fluorescent lamp, low-pressure mercury lamp, high-pressure mercury lamp, ultra-high-pressure mercury lamp, xenon lamp, carbon arc lamp, solar lamp, etc. The radiations include microwaves, EUV, etc. In addition, laser rays for use in microprocessing of semiconductors, such as LED, semiconductor laser ray, 248 nm KrF excimer laser ray, 193 nm ArF excimer laser ray and others, are also favorably used in the invention. These lights may be monochromatic lights, or may also be lights of different wavelengths (mixed lights).

In photoexposure, the light intensity is preferably within a range of from 1 mW/cm² to 50 mW/cm². When the light intensity is at least 1 mW/cm², then the producibility may increase since the photoexposure time may be reduced; and when the light intensity is at most 50 mW/cm², then it is favorable since the properties of the permanent film formed may be prevented from being degraded owing to side reaction. Also preferably, the dose in photoexposure is within a range of from 5 mJ/cm² to 1000 mJ/cm². The dose of 5 mJ/cm² or more can prevent decrease of the photoexposure margin and occurrence of problems in that the photocuring is insufficient and the unreacted matter is adhere to mold. On the other hand, The dose of more than 1000 mJ/cm² can prevent degradation of the permanent film due to decomposition of the composition.

Further, in photoexposure, the oxygen concentration in the atmosphere may be controlled to be less than 100 mg/L by introducing an inert gas such as nitrogen or argon into the system for preventing the radical polymerization from being retarded by oxygen.

In the production method of cured product of the invention, after the pattern layer is cured through photoirradiation, the cured pattern may preferably be further cured under heat given thereto (post-curing step). The heating may be conducted before or after the mold is released from the patterning layer after the light irradiation. The pattering layer is preferably heated after the mold is released. Thermal curing of the composition of the invention after photoirradiation is preferably attained at 150 to 280° C., more preferably at 200 to 250° C. The heating time is preferably from 5 to 60 minutes, more preferably from 15 to 45 minutes.

In the patterning method of the invention, the dose of photoirradiation in photoimprint lithography may be sufficiently larger than the dose necessary for curing. The dose necessary for curing may be suitably determined depending on the degree of consumption of the unsaturated bonds in the curable composition for photoimprints and on the tackiness of the cured film as previously determined.

In the photoimprint lithography applied to the invention, the substrate temperature in photoirradiation may be room temperature; however, the photoirradiation may be attained under heat for enhancing the reactivity. In the previous stage of photoirradiation, preferably, the system is kept in vacuum as effective for preventing contamination with bubbles or contamination with oxygen or for preventing the reduction in reactivity, and as effective for enhancing the adhesiveness of the curable composition for imprints with mold. The system may be subjected to photoirradiation while still kept in vacuum. In the invention, the vacuum degree in photoirradiation is preferably from 10⁻¹ Pa to ordinary pressure.

The curable composition for photoimprints of the invention can be produced by mixing the above-mentioned ingredients. After the ingredients are mixed, the resulting mixture may be filtered through a filter having a pore size of from 0.05 μm to 5.0 μm to give a solution. The ingredients may be mixed and dissolved to prepare the curable composition, generally at a temperature falling within a range of from 0° C. to 100° C. The filtration may be effected in multiple stages, or may be repeated more than once. The solution once filtered may be again filtered. Not specifically defined, the material of the filter may be any one, for example, polyethylene resin, polypropylene resin, fluororesin, nylon resin, etc.

### [Cured Product]

The cured product thus formed according to the production method for cured product of the invention as described in the above can be used as a permanent film (resist for structural members) for use in liquid-crystal displays (LCD) and others, or as an etching resist. After its production, the permanent film may be bottled in a container such as a gallon bottle or a coated bottle, and may be transported or stored. In this case, the container may be purged with an inert gas such as nitrogen, argon or the like for preventing the film therein from being degraded. The permanent film may be transported or stored at ordinary temperature, but for preventing the film from being degraded, it is preferably transported or stored at a controlled temperature of from −20° C. to 0° C. Needless-to-say, the film is shielded from light to such a level on which its reaction does not go on.

The elasticity recovery of the cured product of the invention is preferably at least 70%, more preferably at least 75%, even more preferably at least 80%, from the viewpoint of favorably using it as constitutive members of liquid-crystal display devices.

### [Members of Liquid-Crystal Display Devices]

The curable composition for photoimprints of the invention is applicable to semiconductor integrated circuits, recording materials, members of liquid-crystal display devices, especially favorably to members of liquid-crystal display devices, more favorably to etching resists for flat panel displays.

In case where the composition for photoimprints of the invention is used as an etching resist, first, a nano-order micropattern is formed on a substrate, for example, a silicon wafer with a thin film of SiO₂ or the like formed thereon, according to the production method for cured product of the invention. Next, using hydrogen fluoride or the like in wet etching, or using an etching gas such as CF₄ in dry etching, a desired pattern is formed on the substrate.

### Examples

The characteristics of the invention are described more concretely with reference to Production Examples and Examples given below. In the following Examples, the material used, its amount and the ratio, the details of the treatment and the treatment process may be suitably modified or changed not overstepping the scope of the invention. Accordingly, the invention should not be limitatively interpreted by the Examples mentioned below.

### (Preparation of Curable Composition for Photoimprints)

As in the formulations shown in Table below, a photopolymerizable monomer, a photopolymerization initiator, an antioxidant, a coupling agent, a surfactant and a mold release were mixed to prepare curable compositions for photoimprints of Examples and Comparative Examples. In the Table, the unit is % by mass. The materials used are mentioned below.

As Comparative Example 7 herein, Example 10 in JP-T 2002-512585 was duplicated. As Comparative Example 8 herein, Example 1 in JP-A 2005-263946 was duplicated.

### <Photopolymerizable Monomers>

A-1: monofunctional acrylic monomer, Biscoat 160 (by Osaka Organic Chemical Industry)
A-2: monofunctional acrylic monomer, Light Acrylate L-A (by Toa Gosei)
B-1: 2-(2-vinyloxyethoxy)ethyl acrylate, VEEA (by Nippon Shokubai)
B-2: difunctional acrylic monomer, NPGDA (by Nippon Kayaku)
C-1: trifunctional acrylic monomer, M309 (by Toa Gosei)
C-2: Produced according to the following production method.

2,2-bis(hydroxymethyl)propionic acid (by Tokyo Chemical) (20.0g) was dissolved in N-methylpyrrolidinone (NMP) (150 ml), and sodium hydrogencarbonate (by Wako Pure Chemical) (13.8 g) was added thereto, and then allyl bromide (by Tokyo Chemical) (19.8 g) was thereto. The inner temperature was elevated up to 80° C., and this was stirred for 8 hours, and then left cooled. When the inner temperature became lower than 35° C., NMP (50 ml) was added to it, then 3-chloropropionyl chloride (by Tokyo Chemical) (60.6 g) was dropwise added thereto, and thereafter the inner temperature was kept at 50° C. and this was stirred for 2 hours and then left cooled. When the inner temperature became lower than 35° C., aqueous saturated sodium hydrogencarbonate solution (400 ml) was dropwise added to it, then this was processed for liquid-liquid separation with ethyl acetate (400 ml) added thereto. The organic layer was washed with aqueous 0.2 N hydrochloric acid solution (250 ml). The organic layer was dried with magnesium sulfate (30 g), and then the filtrate was concentrated to give a crude product C-2-1.

Next, C-2-1 was dissolved in acetonitrile (200 ml), then triethylamine (by Wako Pure Chemical) (45.3 g) was added thereto and stirred at room temperature for 4 hours. Aqueous sodium hydrogencarbonate solution (sodium hydrogen carbonate 5 g+water 300 ml) was added to it. This was processed for liquid-liquid separation with ethyl acetate (300 ml) added thereto, and the organic layer was washed with aqueous 1 N hydrochloric acid solution (200 ml) and saturated saline water (200 ml). The organic layer was dried with magnesium sulfate (20 g), and the filtrate was concentrated to give a crude product C-2.

The obtained crude product was purified through silica gel column chromatography to give C-2 (38 g). The process yield was 90%.

¹H NMR of the obtained C-2 and the viscosity data measured with an E-type viscometer thereof are shown below.

¹H NMR (300 MHz, CDCl₃): δ 6.4 (d,2H), δ 6.1 (d,2H), δ 6.0-5.8 (m,1H), δ 5.9 (d,2H), δ 5.3 (dd,2H), δ 4.6 (d,2H), δ 4.4 (s,4H), δ 1.3 (s,3H)

Viscosity: 14.1 mPa·s (25° C.)

Molecular weight: 282.29

### Structural Formula C-2:

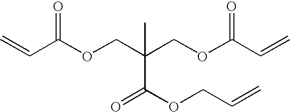

### C-3: Produced According to the Following Production Method.

A mixed solution of Denacol acrylate (Nagase Chemtec's DA-111) (70g), triethylamine (57 g) and ethyl acetate (700 ml) was cooled to 10° C. in an ice bath. Acryloyl chloride (by Tokyo Chemical) (37 ml) was dropwise added to the mixed solution. This was reacted at the same temperature for 2 hours, then the disappearance of Denacol acrylate was confirmed in thin-layer chromatography, and the reaction mixture was extracted with ethyl acetate (300 ml), water (200 ml) and saturated saline water (200 ml) added thereto. The organic layer was separated, and ethyl acetate was evaporated away under reduced pressure to give a pale yellow liquid. A polymerization inhibitor 2,5-di-tert-butylhydroquinone (1 g) was added to the obtained pale yellow liquid and subjected to distillation under reduced pressure, thereby giving a compound C-3 as a colorless liquid (54 g, yield 60%).

¹H-NMR of the obtained compound and the viscosity data measured with an E-type viscometer thereof are shown below.

¹H-NMR (300 MHz, CDCl₃): δ 3.6 (d,2H), 4.0 (d,2H), 4.4 (dd,2H), 5.2-5.4 (m,3H), 5.8-6.0 (m, 3H), 6.2 (dd,2H), 6.5 (dd,2H)

Viscosity: 7.4 mPa·s (25° C.)

Molecular weight: 240.25

### Structural Formula C-3:

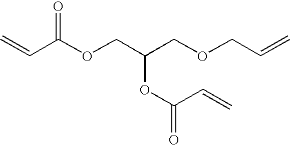

### <Photopolymerization Initiators>

I-1: Lucirin TPO-L (by BASF)

### <Antioxidant>

AO-1: Sumilizer GA-80 (by Sumitomo Chemical)

### <Coupling Agent>

SC-1: KBM 503 (by Shin-etsu Silicone)

### <Surfactant>

W-1: Megafac F780F (by Dai-Nippon Ink Chemical)

The molecular weight of the above-mentioned compounds is described below.

TABLE 1

| | | Number of | |
|---|---|---|---|
| | Molecular | Functional | Viscosity |
| | Weight | Groups | (mPa · s) |
| A-1 | 162 | 1 | 2.5 |
| A-2 | 240 | 1 | 4.5 |
| B-1 | 186 | 2 | 3.9 |
| B-2 | 212 | 2 | 5.0 |
| C-1 | 296 | 3 | 72.0 |
| C-2 | 282 | 3 | 14.1 |
| C-3 | 240 | 3 | 7.0 |
| I-1 | 316 | — | — |

### <Measurement of Composition Viscosity>

Compositions comprising the polymerizable monomer, the photopolymerization initiator, the surfactant and the antioxidant shown in the above Table were prepared, and stirred. Before cured, the viscosity of the composition was measured with a rotary viscometer, Toki Sangyo's RE-80L Model, at 25±0.2° C.

The revolution speed in measurement was 100 rpm for a range of from 0.5 mPa·s to less than 5 mPa·s; 50 rpm for a range of from 5 mPa·s to less than 10 mPa·s; 20 rpm for a range of from 10 mPa·s to less than 30 mPa·s; 10 rpm for a range of from 30 mPa·s to less than 60 mPa·s.

### <Patterning>

The pattern transferred onto the resist was checked for the reproducibility for the original mold pattern. Concretely, each composition was applied onto a glass substrate by spin coating to form a layer having a thickness of 3.0 μm thereon. The spin-coated substrate was set in an imprinting device with a light source of a high-pressure mercury lamp (by ORC) (lamp power, 2000 mW/cm²), and while a mold was kept in contact with the resist, this was kept in a reduced-pressure atmosphere (vacuum degree, 0.5 Torr) for 10 minutes and degassed. The mold pressure was 0.8 kN and the vacuum degree during photoexposure was 10 Torr (about 1.33×10⁴ Pa). The mold was formed of polydimethylsiloxane (Toray Dow-Corning's SILPOT 184, cured at 80° C. for 60 minutes) and had a line/space pattern of 10 μm with a groove depth of 4.0 μm. Under the condition, the mold was pressed against the resist, and exposed to light (240 mJ/cm²) through the surface of the mold. After the photoexposure, the mold was removed, and the resist pattern was thus formed. Further, the obtained resist pattern was baked in an oven at 230° C. for 30 minutes and was thus completely cured. The transferred pattern profile was observed with a scanning electronic microscope and an optical microscope, and the pattern profile was evaluated according to the following standards. Point 3 or more is on a practicable level.

5: mold profile transfer ratio, 95% or more.

4: mold profile transfer ratio, from 90% to less than 95%.

3: mold profile transfer ratio, from 80% to less than 90%.

2: mold profile transfer ratio, from 70% to less than 80%.

1: mold profile transfer ratio, less than 70%.

### <Elasticity Recovery>

The elastic recovery was evaluated. Each composition was applied onto a glass substrate by spin coating to form a layer having a thickness of 3.0 μm thereon. With no mold attached thereto, the spin-coated substrate was exposed to light for 10 mW and 200 mJ in a nitrogen atmosphere. Next, this was baked in an oven at 230° C. for 30 minutes and the film was cured. A pillar sample of the film, 20 μm×30 v×4 μm was tested with Shimadzu's DUH-W201 to measure its elastic recovery ratio. The tested samples were evaluated according to the following standards. Films having a higher elastic recovery ratio are better; however, for applications not requiring elastic recovery, the elastic recovery ratio may be on the level 1.

5: elastic recovery ratio, 70% or more.

4: elastic recovery ratio, from 60 to 70%.

3: elastic recovery ratio, from 50 to 60%.

2: elastic recovery ratio, from 40 to 50%.

1: elastic recovery ratio, 40% or less.

TABLE 2

| | Example 1 | Example 2 | Example 3 | Example 4 | Example 5 | Example 6 | Example 7 |
|---|---|---|---|---|---|---|---|
| A-1 | | | | | | | |
| A-2 | 86.0 | 48.2 | 49.5 | 29.8 | 33.9 | | |
| B-1 | | | | | | | |
| B-2 | | 37.8 | | 56.2 | | 46.5 | 46.5 |
| C-1 | | | 36.5 | | 52.1 | 39.5 | |
| C-2 | | | | | | | 39.5 |
| C-3 | | | | | | | |
| I-1 | 1.0 | 1.0 | 1.0 | 1.0 | 1.0 | 1.0 | 1.0 |
| AO-1 | 2.0 | 2.0 | 2.0 | 2.0 | 2.0 | 2.0 | 2.0 |
| SC-1 | 10.0 | 10.0 | 10.0 | 10.0 | 10.0 | 10.0 | 2.0 |
| W-1 | 1.0 | 1.0 | 1.0 | 1.0 | 1.0 | 1.0 | 2.0 |
| Total | 100.0 | 100.0 | 100.0 | 100.0 | 100.0 | 100.0 | 2.0 |

| | | | Example | Example | Example | Example |
|---|---|---|---|---|---|---|
| | Example 8 | Example 9 | 10 | 11 | 12 | 13 |
| A-1 | | 3.2 | 8.6 | 18.8 | | 9.5 |
| A-2 | | | | | 15.4 | |
| B-1 | | | | | 19.3 | 9.8 |
| B-2 | 46.5 | 62.4 | 57.0 | 46.8 | 32.7 | 47.3 |
| C-1 | | 20.4 | 20.4 | 20.4 | 18.6 | 19.4 |
| C-2 | | | | | | |
| C-3 | 39.5 | | | | | |
| I-1 | 1.0 | 1.0 | 1.0 | 1.0 | 1.0 | 1.0 |
| AO-1 | 2.0 | 2.0 | 2.0 | 2.0 | 2.0 | 2.0 |
| SC-1 | 10.0 | 10.0 | 10.0 | 10.0 | 10.0 | 10.0 |
| W-1 | 1.0 | 1.0 | 1.0 | 1.0 | 1.0 | 1.0 |
| Total | 100.0 | 100.0 | 100.0 | 100.0 | 100.0 | 100.0 |

TABLE 3

| | Example 1 | Example 2 | Example 3 | Example 4 | Example 5 | Example 6 | Example 7 |
|---|---|---|---|---|---|---|---|
| Viscosity | 6.1 | 6.5 | 22.0 | 6.8 | 32.1 | 46.0 | 12.1 |
| Imprintability | 5 | 5 | 4 | 5 | 4 | 3 | 4 |
| Elastic | 1 | 3 | 4 | 4 | 5 | 5 | 5 |
| Recovery | | | | | | | |

| | | | Example | Example | Example | Example |
|---|---|---|---|---|---|---|
| | Example 8 | Example 9 | 10 | 11 | 12 | 13 |
| Viscosity | 8.4 | 16.3 | 13.5 | 11.1 | 15.9 | 15.6 |
| Imprintability | 5 | 5 | 4 | 3 | 3 | 3 |
| Elastic | 5 | 5 | 5 | 5 | 5 | 5 |
| Recovery | | | | | | |

TABLE 4

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| A-1 | 22.4 | 46.5 | | | | |
| A-2 | | | | | | |
| B-1 | | | 22.4 | 46.5 | | |
| B-2 | 43.2 | 19.1 | 43.2 | 19.1 | 26.0 | |
| C-1 | 20.4 | 20.4 | 20.4 | 20.4 | 60.0 | 86.0 |
| C-2 | | | | | | |
| C-3 | | | | | | |
| I-1 | 1.0 | 1.0 | 1.0 | 1.0 | 1.0 | 1.0 |
| AO-1 | 2.0 | 2.0 | 2.0 | 2.0 | 2.0 | 2.0 |
| SC-1 | 10.0 | 10.0 | 10.0 | 10.0 | 10.0 | 10.0 |
| W-1 | 1.0 | 1.0 | 1.0 | 1.0 | 1.0 | 1.0 |
| Total | 100.0 | 100.0 | 100.0 | 100.0 | 100.0 | 100.0 |

TABLE 5

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| Viscosity | 10.6 | 8.2 | 13.5 | 11.6 | 52.5 | 68.0 | 250.0 | 3500 |
| Imprintability | 2 | 1 | 2 | 1 | 2 | 1 | 1 | 1 |
| Elasticity | immeasurable | immeasurable | immeasurable | immeasurable | immeasurable | immeasurable | immeasurable | immeasurable |
| Recovery | | | | | | | | |

As is obvious from the above Tables, it is known that the compositions of the invention exhibit excellent patterning accuracy. Further, some compositions are excellent also in elastic recovery, and therefore, when used in applications for panel spacers and others in liquid-crystal display (LCD) devices, the compositions of the invention are good.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 308839/2008 filed on Dec. 3, 2008, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A curable composition for photoimprints containing a photopolymerizable monomer (A) and a photopolymerization initiator (B), wherein the proportion of the compound having a molecular weight of at most 190 in the composition is at most 20% by mass, and the viscosity of the composition is from 3 to 50 mPa·s at 25° C.

2. The composition according to claim 1, wherein the proportion of the compound having a molecular weight of at most 190 in the composition is at most 10% by mass.

3. The composition according to claim 1, wherein the proportion of the compound having a molecular weight of at most 190 in the composition is at most 5% by mass.

4. The composition according to claim 1, wherein the viscosity of the composition is from 3 to 30 mPa·s at 25° C.

5. The composition according to claim 1, wherein the viscosity of the composition is from 3 to 20 mPa·s at 25° C.

6. The composition according to claim 1, wherein at least one of the photopolymerizable monomer (A) has a (meth)acrylate group.

7. The composition according to claim 1, wherein at least one of the photopolymerizable monomer (A) has a viscosity of at most 10 mPa·s at 25° C.

8. The composition according to claim 1, wherein at least one of the photopolymerizable monomer (A) has a molecular weight of from 190 to 350.

9. The composition according to claim 1, wherein at least one of the photopolymerizable monomer (A) is di- or more functional.

10. The composition according to claim 1, which contains at least two monomers as the photopolymerizable monomer (A).

11. The composition according to claim 1, which contains a di- or more functional photopolymerizable monomer in an amount of at least 50% by mass of all the photopolymerizable monomers contained in the composition.

12. The composition according to claim 1, which contains
a difunctional photopolymerizable monomer in an amount of at least 50% by mass of all the photopolymerizable monomers contained in the composition.

13. The composition according to claim 1, which contains a mono functional photopolymerizable monomer in an amount of from 10 to 100% by mass of all the photopolymerizable monomers contained in the composition.

14. The composition according to claim 10, which contains from 20 to 90% by weight of the photopolymerizable monomer (A).

15. The composition according to claim 10, which contains from 0.1 to 15% by weight of the photopolymerization initiator (B).

16. The composition according to claim 1, which contains a surfactant.

17. The composition according to claim 1, which contains an antioxidant.

18. A method for forming a cured product, comprising using a composition of claim 1.

19. The method for producing a cured product according to claim 18, comprising providing a curable composition for photoimprints containing a photopolymerizable monomer (A) and a photopolymerization initiator (B), wherein the proportion of the compound having a molecular weight of at most 190 in the composition is at most 20% by mass, and the viscosity of the composition is from 3 to 50 mPa·s at 25° C.,
applying the curable composition for photoimprints onto a substrate to form a patterning layer thereon,
pressing a mold against the surface of the patterning layer, and
irradiating the patterning layer with light.

20. The method for producing a cured product according to claim 19, which further comprises heating the light-irradiated patterning layer.
